(19) United States
(12) Patent Application Publication
(10) Pub. No.: US 2012/0200969 A1
(43) Pub. Date: Aug. 9, 2012

(54) Resistive Element, Infrared Light Sensor, and Electrical Device

(75) Inventor: Sakyo Hirose, Nagaokakyo-shi (JP)

(73) Assignee: MURATA MANUFACTURING CO., LTD, Nagaokakyo-shi (JP)

(21) Appl. No.: 13/452,034

(22) Filed: Apr. 20, 2012

Related U.S. Application Data
(63) Continuation of application No. PCT/JP2010/068806, filed on Oct. 25, 2010.

(30) Foreign Application Priority Data
Oct. 26, 2009 (JP) 2009-245086

(51) Int. Cl. H02H 3/08; H01C 13/00; H01C 7/13

(52) U.S. Cl. 361/93.7; 338/20; 338/18

(57) ABSTRACT

A resistive element which includes an element body that contains, as its main constituent, an oxide conductor represented by RBaMn₂O₆ (wherein R is at least one selected from among Nd, Sm, Eu, Gd, Tb, Dy, Ho, and Y) and which has a negative temperature coefficient; and a pair of electrodes for applying an electric field to a surface layer section of the element body. When the resistive element is used in, for example, an infrared light sensor, infrared light is detected in such a way that measures an electric current flowing through the element body, which is correlated with the resistance of the element body, when an electric field with an electric field intensity of 100 V/cm or more is applied to the element body.

### CROSS REFERENCE TO RELATED APPLICATIONS

The present application is a continuation of International application No. PCT/JP2010/068806, filed Oct. 25, 2010, which claims priority to Japanese Patent Application No. 2009-245086, filed Oct. 26, 2009, the entire contents of each of which are incorporated herein by reference.

### FIELD OF THE INVENTION

This invention relates to a resistive element which has a negative temperature coefficient, an infrared light sensor configured with the use of the resistive element, and an electrical device using the resistive element in application on inrush current suppression.

### BACKGROUND OF THE INVENTION

In recent years, surface-mountable laminated chip thermistors have been used widely, and in particular, common negative characteristic (NTC) thermistors which have negative temperature coefficients have been used for not only conventional applications of sensing and compensating temperatures, but also applications such as hydrogen sensors, infrared light sensors, and non-contact temperature sensors in combination of other members. In these sensors, changes in external environment to be sensed are converted through a catalyst material or by collecting light through an infrared light lens, and the amounts of changes are read for sensing by the NTC thermistors. Therefore, the use of an NTC thermistor which undergoes a significant change in resistance with a smaller change in temperature makes it possible to increase the sensitivity.

In addition, resistive elements of interest to this invention, which have negative temperature coefficients, include CTR (Critical Temperature Resistor) elements. The CTR elements undergo rapid changes in resistance with temperatures, as compared with common NTC thermistors which have negative temperature coefficients. More specifically, the positive characteristic (PTC) thermistors which have positive temperature coefficients and typically undergo rapid increases in resistance on exceeding a certain temperature exhibit inverse characteristics to the characteristics of the CTR elements. Therefore, these CTR elements are considered more suitable for applications for sensing minor changes in temperature, and for applications as power thermistors, that is, for suppressing inrush currents, than common NTC thermistors.

The CTR elements mentioned above include, for example, a CTR element disclosed in Patent Document 1. The CTR element described in Patent Document 1 uses a VO₂ based oxide as a material for the element body. However, the CTR element using the VO₂ based oxide has been ever commercialized, but failed to be spread widely, because of problems such as poor stability with characteristics degraded due to repeated use, difficulty in controlling the operating temperature (transition temperature), and the narrow controllable temperature range.

In recent years, besides the material disclosed in Patent Document 1, some materials which exhibit CTR characteristics have been proposed with a focus on materials in a strongly-correlated electron system, but have problems such as low operating temperatures below room temperature, and low rates of resistance changes.

If a CTR element can be achieved which exhibits a large change in resistance at any temperature not less than room temperature, and further allows for varying the operating temperature in a wide temperature range, there is a possibility that the CTR element can be used not only for the detection of temperatures or infrared light, but also as power thermistors and thermistors for ESD measure.

In addition, the demand has been increased for infrared light sensors or bolometers using NTC thermistors as motion detection sensors, and in order to sense a human body or a heating element with a higher sensitivity, a resistive element is effective which includes an element body for developing CTR characteristics. However, the use of the VO₂ based oxide in the CTR elements for these applications has problems in terms of reliability and regulation of detection temperature as mentioned above.

In order to solve the problems described above, the inventor has focused attention on RBaMn₂O₆ (R is at least one selected from among Nd, Sm, Eu, Gd, Tb, Dy, Ho, and Y) based materials disclosed in Patent Document 2 or Non-Patent Document 1, and made studies on the materials. The RBaMn₂O₆ based materials are known to maintain a particular state of charge ordering type insulator at not less than room temperature, and collapse the charge ordering with an increase in temperature to provide metallic conduction and exhibit CTR characteristics. In addition, the RBaMn₂O₆ based materials have operating temperatures which can be varied by changing the type of the rare earth element R. However, because of the low rates of resistance change on the order of one digit, the actual applications have to be limited.

Patent Document 1: Japanese Patent Application Laid-Open No. 5-152103

Patent Document 2: Japanese Patent Application Laid-Open No. 2007-99554

Non-Patent Document 1: T. Nakajima, H. Kageyama, and Y. Ueda, “Successive Phase Transitions in a Metal-Ordered Manganite Perovskite YBaMn2O6” J. Phys. Chem. Solids, 63 (2002) 913

### SUMMARY OF THE INVENTION

Therefore, an object of the present invention is to provide a resistive element which can solve the problems as described above.

Another object of this invention is to provide an infrared light sensor configured with the use of the resistive element.

Yet another object of this invention is to provide an electrical device using the resistive element in application on inrush current suppression.

### Means for Solving the Problem

A first aspect of this invention is directed to a resistive element including: an element body that contains, as its main constituent, an oxide conductor represented by the chemical formula: RBaMn₂O₆ (R is at least one selected from among Nd, Sm, Eu, Gd, Tb, Dy, Ho, and Y) and has a negative temperature coefficient; and at least a pair of electrodes provided for applying an electric field to at least a portion of the element body.

The resistive element according to this aspect is characterized by the magnitude of the electric field intensity adopted in the application of an electric field through the pair of electrodes to the element body, and characterized in that the resistance of the element body is changed significantly for use by applying an electric field with an electric field intensity of 100 V/cm or more.

In preferred embodiments, the resistive element can be, for example, used for detecting infrared light in such a way that measures an electric current flowing through the element body when an electric field with an electric field intensity of 100 V/cm or more is applied through the pair of electrodes to the element body, and can be used for an application of inrush current suppression in such a way that the resistive element is connected in series with an electric current line to a protected circuit so that an electric field with an electric field intensity of 100 V/cm or more is applied through the pair of electrodes to the element body when an inrush current flows into the protected circuit.

Another aspect of the invention is directed to an infrared light sensor configured with the use of the resistive element described above.

The infrared light sensor according to this invention is characterized in that it comprises a resistive element including: an element body that contains, as its main constituent, an oxide conductor represented by the chemical formula: RBaMn₂O₆ mentioned above and has a negative temperature coefficient; and at least a pair of electrodes provided for applying an electric field to a surface layer section of the element body, as well as a power source for applying an electric field of 100 V/cm or more through the pair of electrodes to the element body, and a current measuring means for measuring an electric current flowing through the element body when an electric field of 100 V/cm or more is applied from the power source. Further, this infrared light sensor is adapted to detect the resistance change of the element body, which is produced by a temperature change due to infrared light received by the surface layer section of the element body, by measuring the resistance change as a current change with the use of the current measuring means.

It is to be noted that the infrared light sensor also functions as a temperature sensor, because the temperature change in the surface layer section of the element body is detected for the detection of infrared light. Therefore, in this specification, the term “infrared light sensor” is used for the same meaning as the “temperature sensor”.

Another aspect of this invention is directed to an electrical device including a protected circuit, a power source, and an electric current line for supplying electric power to the protected circuit, wherein a resistive element for suppressing an inrush current into the protected circuit is connected in series with the electric current line.

In the electrical device according to this aspect, the resistive element including: an element body that contains, as its main constituent, an oxide conductor represented by the chemical formula: RBaMn₂O₆ mentioned above and has a negative temperature coefficient; and at least a pair of electrodes provided for applying an electric field to at least a portion of the element body, and the electrical device is characterized in that an electric field of 100 V/cm or more is applied through the electrodes to the element body when an inrush current flows into the protected circuit.

It is to be noted that what is required for the element body with a negative temperature coefficient for use in this aspect is to have a negative temperature coefficient at the operating temperature, and for example, the element body may be metallic, that is, show a positive temperature coefficient in a higher temperature region than the operating temperature.

It has been determined that an element body, which contains, as its main constituent, an oxide conductor represented by the chemical formula: RBaMn₂O₆, and has a negative temperature coefficient, exhibits CTR characteristics such as a rapid decrease in resistance at a certain temperature, under a certain level of electric field intensity such as 100 V/cm or more. In addition, it has been also determined that the operating (transition) temperature in the CTR characteristics can be varied by varying the electric field intensity or changing the type of the rare earth element R.

Therefore, when the resistive element including the element body is used to configure an infrared light sensor, the sensitivity of this sensor can be increased, and a sensor can be achieved which is able to detect a wide range of temperatures, for example, from room temperature to on the order of 200° C.

In addition, when the resistive element including the element body is used for the application of suppressing an inrush current into the protected circuit, the inrush current can be suppressed more efficiently with the element which has a smaller chip size, because of a higher rate of resistance change as compared with the case of using an NTC thermistor.

### BRIEF EXPLANATION OF THE DRAWINGS

FIGS. 1(a) and 1(b) are diagrams showing the temperature dependence of resistances of a resistive element, measured under various electric field intensities, wherein FIG. 1(a) is GdBaMn₂O₆ and FIG. 1(b) is DyBaMn₂O₆ as an oxide constituting an element body of the resistive element.

FIG. 2 is a diagram showing the temperature dependence of resistance for comparison between the case of a resistive element for use in this invention and the case of a common NTC thermistor.

FIG. 3 is a diagram showing the time dependence of resistance for comparison between the case of a resistive element for use in this invention and the case of a common NTC thermistor.

FIG. 4 is a front view schematically illustrating an infrared light sensor according to an embodiment of this invention.

FIG. 5 is a block diagram schematically illustrating an electrical device according to another embodiment of this invention.

FIG. 6 is a cross-sectional view illustrating a preferable structure of the resistive element shown in FIG. 5.

FIG. 7 is a diagram showing the temperature dependence of resistances measured under various electric field intensities, for a resistive element according to sample 4 prepared in an experimental example.

FIG. 8 is a diagram for explaining how to obtain a transition temperature (T_{CTR}) for sample 4 prepared in the experimental example.

FIG. 9 is a diagram illustrating showing the temperature dependence of resistance for a resistive element according to sample 4 prepared in the experimental example.

### DETAILED DESCRIPTION OF THE INVENTION

A resistive element for use in this invention includes: an element body that comprises an oxide containing, as its main constituent, an oxide conductor represented by the chemical formula: RBaMn₂O₆ (R is at least one selected from among Nd, Sm, Eu, Gd, Tb, Dy, Ho, and Y) and having a double perovskite structure, and has a negative temperature coefficient; and at least a pair of electrodes provided for applying an electric field to at least a portion of the element body. This resistive element is used while a bias electric field or a trigger electric field with an electric field intensity of 100 V/cm or more is applied through the pair of electrodes to the element body.

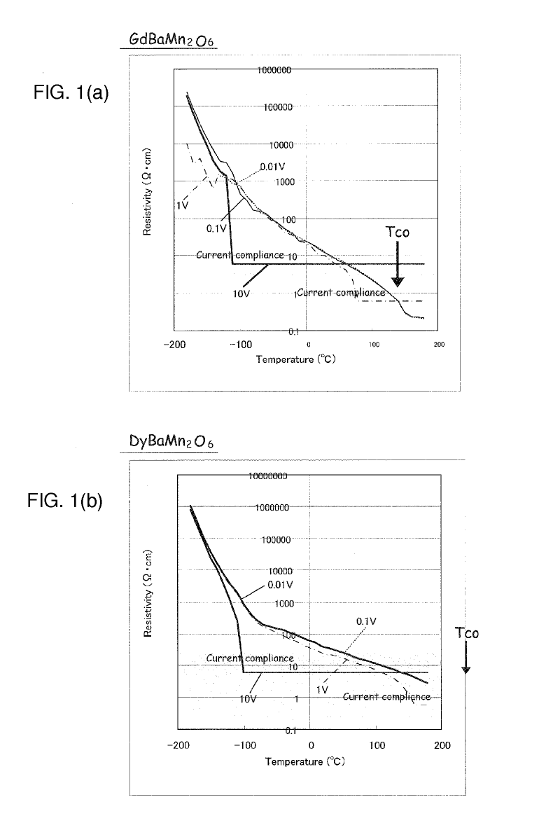

As described above, it has been determined that the use of the resistive element under an electric field intensity of 100 V/cm or more can achieve voltage-dependent precipitous CTR characteristics. To explain more specifically, when the temperature dependence of resistances of the resistive element, measured under various electric field intensities, was examined for each case of using (a) GdBaMn₂O₆ and using (b) DyBaMn₂O₆ as the oxide constituting the element body of the resistive element, results were obtained as shown in FIG. 1.

As shown in FIGS. 1(a) and 1(b), in each case of GdBaMn₂O₆ and DyBaMn₂O₆, it has been confirmed that only substantially the same temperature characteristics of resistance as in common NTC thermistors are exhibited between 0.1 V and 1V when the applied voltage is increased from 0.01 V, whereas a high rate of resistance change in one or more digits is shown to reach a two-digit rate of resistance change when the applied voltage is increased to 10 V.

In FIGS. 1(a) and 1(b), the applied voltage of 0.01 V corresponds to an electric field intensity of 2.5 V/cm, the applied voltage of 0.1 V corresponds to an electric field intensity of 25 V/cm, the applied voltage of 1 V corresponds to an electric field intensity of 250 V/cm, and the applied voltage of 10 V corresponds to an electric field intensity of 2500 V/cm.

It is to be noted that because the measuring instrument used has a current limit of 0.5 A, the lower resistance side fails to indicate accurate resistivity in FIG. 1. In addition, the temperature corresponding to a charge ordering transition temperature (T_{CC}) is shown in FIG. 1, and the T_{CO} of DyBaMn₂O₆ shown in FIG. 1(b) is approximately 220° C. which is higher than the temperature measurement range.

In addition, it has been found that the operating (transition) temperature can be changed by varying the applied voltage. In this case, the transition temperature has a tendency to converge to a certain temperature with an increase in applied voltage, and for example, in the case of (a) GdBaMn₂O₆, the transition temperature has been found to converge to a temperature around −100° C. The applied voltage varied therein refers to the varied electric field intensity applied between the pair of electrodes, and it is also possible to vary the electric field intensity by varying the distance between the pair of electrodes.

The oxide for use in this invention, containing, as its main constituent, an oxide conductor which is represented by the chemical formula: RBaMn₂O₆ (R is at least one selected from among Nd, Sm, Eu, Gd, Tb, Dy, Ho, and Y) and has a double perovskite structure is turned into a particular state of a charge ordering state in a certain range of temperature. This substance has an average Mn valence of 3.5 from the chemical formula, and this valence generally exhibits metallic conduction. However, carriers are frozen to exhibit semiconducting or insulating properties at temperatures which are not higher than the charge ordering transition temperature (T_{CC}), because of turning into the particular state of charge ordering with Mn³⁺−Mn⁴⁺ (Mn³⁺/Mn⁴⁻=50/50, Average Valence: 3.5) ordered. The oxide has a feature of exhibiting a metal-insulator transition with a change from a state of higher resistance to a state of lower resistance due to the collapse of the charge ordering state at temperatures of T_{CO} or more.

The inventor has considered that the charge ordering state described above is also collapsed by an electric field, an electric current, or Joule heat, and found that the transition temperature can be shifted to achieve a larger change in resistance by the use under a certain level of electric field intensity, such as 100 V/cm or more, as in the invention of the present application.

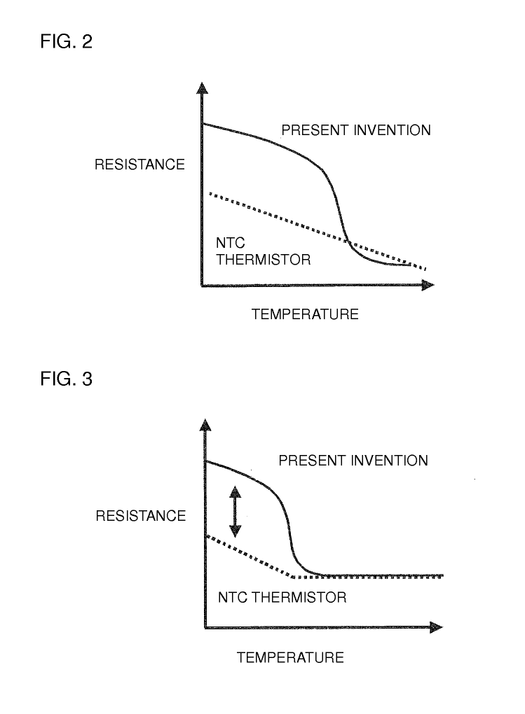

As comparisons between the resistive element for use in the present invention and a common NTC thermistor, FIG. 2 schematically shows temperature dependence of resistance, whereas FIG. 3 schematically shows time dependence of resistance, that is, temperature dependence of resistance under constant voltage and current.

In FIG. 2, the NTC thermistor generally has a feature of a gradual decrease in resistance with an increase in temperature, as indicated by a dotted line. On the other hand, the resistive element according to the present invention has a feature of a rapid decrease in resistance at a certain temperature, as indicated by a solid line. For the changes in resistance with time in the case of applying certain voltage and current to these two types of resistive elements, the resistances are decreased gradually by heat generation of the element body with the passage of time to reach steady states, as shown in FIG. 3. In the case of the resistive element according to the present invention herein, the initial resistance in the case of undergoing a decrease to the same resistance can be expected to be made higher as indicated by a solid line in FIG. 3, than in the case of the common NTC thermistor as indicated by a dotted line, if the composition of the element body, the distance between the pair of electrodes, etc. are adjusted, and if the applied electric field and the operating (transition) temperature are controlled.

If this higher initial resistance can be achieved, for example, when the resistive element according to the present invention is used in series connection with an electric current line as in the case of a common power thermistor, constant voltage and current in accordance with the element resistance will be applied to the resistive element while the power source is turned on, and the resistance value will be decreased gradually so that a sufficient electric current flows through an element or a circuit to which an electric current is to be supplied, as in the case of a common power thermistor. In this case, the resistive element according to the present invention has a high rate of resistance change unlike common power thermistors, and thus has a feature of being able to make the initial resistance higher than in the case of power thermistors as mentioned above. Therefore, when an inrush current flows, the resistive element makes it possible to suppress the inrush current efficiently more than common power thermistors.

Currently, common NTC thermistors are used for this application.

In the case of an NTC thermistor, an inrush current flows to generate heat and decrease the resistance. However, depending on the B constant of the NTC thermistor, the resistance is decreased only on the order of one digit in the case of the NTC thermistor, even when the temperature is increased rapidly by, for example, 100° C. Therefore, there is also a limit on the effect of inrush current suppression, and if high current and voltage are applied, the stress may destroy the NTC thermistor.

In contrast, the oxide constituting the element body of the resistive element according to the present invention originally has a particular state of charge ordering type insulator as mentioned above, in which carriers are present, but frozen. When this state is collapsed by a voltage or a temperature, the resistive element exhibits one- or more-digit change in resistance, which is expected to exhibit higher durability than existing NTC thermistor because of a lower load on the element, that is, because of being able to apply a larger electric current. In addition, this function also makes it possible to use the resistive element according to the present invention inversely as a fuse, that is, inversely as a PTC thermistor, when the resistive element is used under constant voltage and current.

Next, an infrared light sensor will be described as an example of more specific applications of the resistive element according to the present invention.

Conventionally, for example, resistance-type bolometers have been using therein common NTC thermistors, or using VO₂ based ceramics which exhibit CTR characteristics. These are both intended to utilize, when being irradiated with infrared light, temperature increases in surface layer sections, and thus resistance changes, and used as infrared light sensors. Because of this principle, the resistance is preferably changed significantly when infrared light is received.

It is to be noted that when the resistance is changed from R₁ to R₂ with a change from a temperature T₁ to a temperature T₂, the B constant is often used as an index for the rate of resistance change. The B constant is calculated from the following formula.

B constant=Ln(R₁/R₂)/(1/T₁−1/T₂)

where the unit is “Ω” for the resistances R₁ and R₂, and the unit is “K” for the temperatures T₁ and T₂.

In the case of common NTC thermistors, the B constant is on the order of 4000 at most. In addition, the VO₂ based ceramics have the problems of poor controllability and stability because the temperature range which shows a change in resistance is limited to room temperature to 60° C., although a relatively large change in resistance (B constant) is achieved.

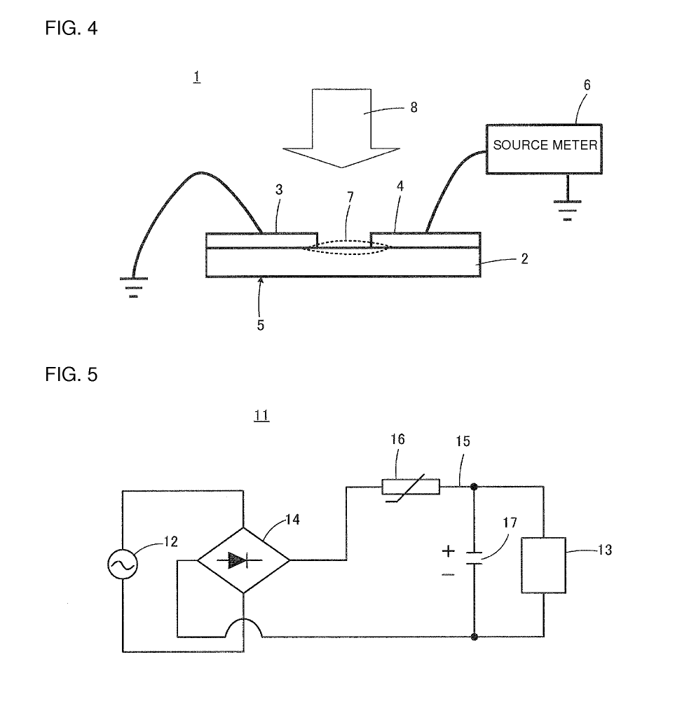

The infrared light sensor according to this invention can solve these problems. FIG. 4 schematically shows an infrared light sensor 1 according to an embodiment of this invention.

Referring to FIG. 4, the infrared light sensor 1 has a resistive element 5 including: a plate-like element body 2 comprising an oxide that contains, as its main constituent, an oxide conductor represented by RBaMn₂O₆ (R is at least one selected from among Nd, Sm, Eu, Gd, Tb, Dy, Ho, and Y) and having a double perovskite structure; and a pair of electrodes 3 and 4 formed on the upper surface of the element body 2 with a predetermined gap interposed therebetween. The infrared light sensor 1 further includes a source meter 6 to serve as a power source for applying an electric field through the pair of electrodes 3 and 4 to the element body 2. This source meter 6 also serves as a current measuring means for measuring an electric current flowing through the element body 2 when an electric field is applied between the electrodes 3 and 4 by the source meter 6.

Electric power supplied from the source meter 6 applies a trigger electric field of 100 V/cm or more through the electrodes 3 and 4 to a surface layer section 7 of the element body 2 at regular intervals. Then, when the surface layer section 7 of the element body 2 is irradiated with infrared light (or heat) 8 to increase the temperature of the surface layer section 7, a large change in resistance will be caused. Therefore, the infrared light sensor makes it possible to achieve outstanding infrared sensitivity.

To give an explanation based on a more specific experimental example, the resistive element 5 configured as shown in FIG. 4 was prepared by preparing the element body 2 composed of a GdBaMn₂O₆ ceramic, and forming, on the upper surface thereof, the two electrodes 3 and 4 with a gap of 100 μm interposed therebetween in accordance with a DC sputtering method. This resistive element 5 was used to constitute the infrared light sensor 1, a voltage of 2.5 V (electric field intensity: 250 V/cm) was applied at regular intervals between the electrodes 3 and 4 from the source meter 6 at room temperature (25° C.), and the electric current flowing between the electrodes 3 and 4 when the voltage was applied was measured by the source meter 6.

As a result, the B constant was 8725 in a temperature range from 30° C. to 35° C., whereas the B constant was 12600 in a temperature range from 35° C. to 40° C. On the other hand, the B constant was 2500 when the same resistive element 5 was used with an electric field intensity of 10 V/cm. In addition, the B constant of a common NTC thermistor is on the order of 4000 at most as mentioned above. More specifically, it is determined that when the resistive element 5 is used under a high electric field intensity such as 250 V/cm, the obtained B constant is three or more times as high as compared with the case with an electric field intensity of 10 V/cm or the case of a common NTC thermistor.

For this reason, the infrared light sensor according to this invention can improve the sensitivity dramatically.

While the infrared light sensor was operated around room temperature in the experimental example described above, it is possible to design the operating temperature of the sensor in a wide range of room temperature to 200° C. by selecting the interelectrode distance and/or the element body material. Therefore, the infrared light sensor can be used not only as a motion sensor at room temperature, but also as a resistance-type bolometer such as a microwave.

Next, a use as an application of inrush current suppression, that is, a power thermistor application will be described as another example of more specific applications of the resistive element according to the present invention. FIG. 5 shows, as a block diagram, an electrical device including a resistive element for an application of inrush current suppression.

Referring to FIG. 5, an electrical device 11 includes an alternating-current source 12 and a protected circuit 13, and the alternating-current source 12 is adapted to supply electric power through a rectifier 14 to the protected circuit 13. A resistive element 16 for the application of inrush current suppression is connected in series with an electric current line 15 for the electric power supply. In addition, a smoothing capacitor 17 is connected in parallel with the protected circuit 13.

Conventionally, NTC thermistors have been often used as the resistive element 16 for the application of inrush current suppression. The NTC thermistor, unlike typical resistors, exhibits a high resistance during power-off and immediately after power-on, and the resistance undergoes a decrease by self-heating after power-on. Therefore, the NTC thermistor is advantageous in that the power consumption can be reduced as compared with typical resistors which have resistance values nearly unchanged even by temperature changes.

For this resistive element 16 for the power thermistor application, in order to achieve a better effect of inrush current suppression and further reduce the power consumption, it is preferable to exhibit a higher resistance during standby (during power-off) and immediately after power-on, and then, make the resistance lower as a result of self-heating. Therefore, the CTR material which has a resistance changed rapidly with an increase in temperature exhibits ideal characteristics as the power thermistor application, while previously known VO₂ materials have the problem of lacking reproducibility and stability as mentioned above.

In this invention, as the resistive element 16, a resistive element is used which includes: an element body comprising an oxide that contains, as its main constituent, an oxide conductor represented by RBaMn₂O₆ (R is at least one selected from among Nd, Sm, Eu, Gd, Tb, Dy, Ho, and Y) and having a double perovskite structure; and at least a pair of electrodes provided for applying an electric field to at least a portion of the element body. Further, the resistive element is designed so that an electric field with an electric field intensity of 100 V/cm or more is applied through the pair of electrodes to the element body when an inrush current flows into the protected circuit 13.

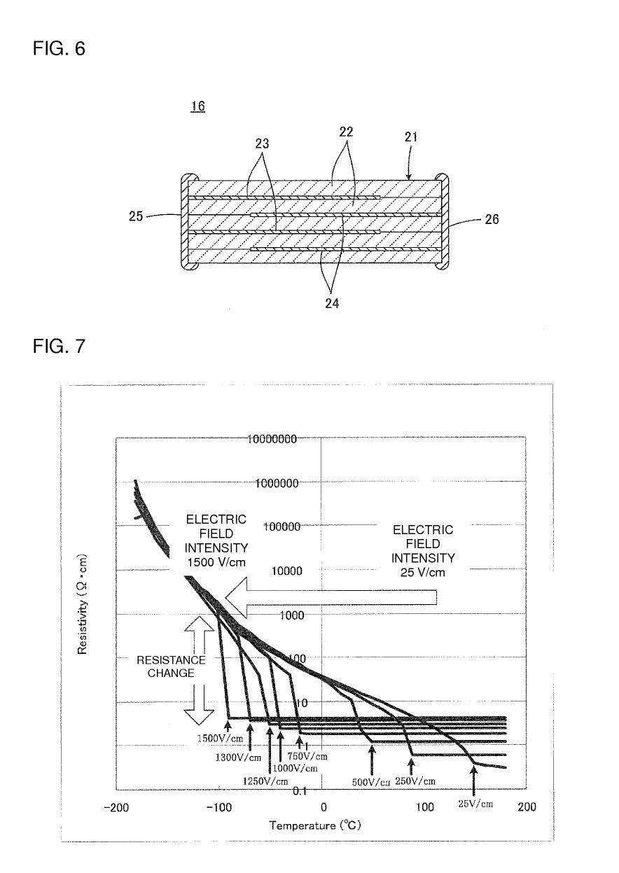

FIG. 6 is a cross-sectional view illustrating a preferable structure of the resistive element 16.

Referring to FIG. 6, the resistive element 16 has a laminated structure. More specifically, the resistive element 16 includes an element body 21, the element body 21 includes a plurality of ceramic layers 22 stacked, and a plurality of internal electrodes 23 and 24 are formed along the interfaces between the ceramic layers 22. In addition, first and second external electrodes 25 and 26 are respectively formed on respective end surfaces of the element body 21, which are opposed to each other. The internal electrodes 23 and 24 mentioned above are classified into a plurality of first internal electrodes 23 electrically connected to the first external electrode 25 and a plurality of second internal electrodes 24 electrically connected to the second external electrode 26, and these first and second internal electrodes 23 and 24 are alternately arranged with respect to the staking direction.

In the case of the resistive element 16 which has this stacked structure, regardless of the external dimensions, the electric field intensity applied to the element body 21 can be changed by changing the thickness of the ceramic layers 22, and it is thus easy to design the resistive element 16 so that an electric field with an electric field intensity of 100 V/cm or more is applied to the element body 21 when an inrush current flows into the protected circuit 13.

To give a more specific explanation based on an experimental example, a GdBaMn₂O₆ ceramic was used to prepare the element body 21 of a stacked structure with planar dimensions of 2.0 mm×1.2 mm so that the resistance value, commonly used as a power thermistor, was 8Ω at room temperature. In this case, when Pd was used as a conductive component for the internal electrodes 23 and 24 to make a design so that the total electrode area was 0.2 mm² after firing, and the thickness of the ceramic layer 22 was 130 μm between the internal electrodes 23 and 24, the resistive element 16 was able to be obtained which achieved an on-target resistance value of approximately 8Ω at room temperature.

When the obtained resistive element 16 was evaluated for RTC (temperature dependency of electrical resistivity) under an electric field intensity of 25 V/cm, the transition temperature was approximately 150° C. with a rate of resistance change less than one digit. However, the rate of resistance change was improved significantly under an electric field intensity of 250 V/cm to achieve a transition temperature of approximately 50° C.

Therefore, according to the present invention, the resistive element 16 exhibits a resistance on the order of 8Ω during power-off around room temperature, and when the power-on causes an inrush current with an electric field intensity of 250 V/cm, the resistance value is changed significantly to exhibit a metal-insulator transition, and down to 0.8Ω or less in a steady state, thereby making it possible to reduce the power consumption. Therefore, the present invention makes it possible to suppress an inrush current efficiently more than common NTC thermistors, and use the resistive element as a power thermistor which is excellent in recovery characteristics.

Next, experimental examples will be described which were carried out for systematically confirming the advantageous effects of this invention.

Barium carbonate (BaCO₃) and manganese oxide (Mn₃O₄) were weighed so that the composition of RBaMn₂O₆ was obtained after firing, whereas at least one of neodymium oxide (Nd₂O₃), samarium oxide (Sm₂O₃), europium oxide (Eu₂O₃), gadolinium oxide (Gd₂O₃), terbium oxide (Tb₄O₇), dysprosium oxide (Dy₂O₃), holmium oxide (Ho₂O₃), and yttrium oxide (Y₂O₃) was weighed so that the compositions shown in Table 1 were provided, further a dispersant and ion-exchange water were weighed, and these materials were blended and subjected to wet mixing for 24 hours with the use of PSZ balls of 2 mm in diameter.

Next, the mixture was subjected to drying then firing at a temperature of 1250° C. for 12 hours in a high-purity Ar atmosphere (99.9999%), and then coarse grinding.

Next, the coarse powder subjected to coarse grinding was subjected to a grinding treatment with the addition of an organic solvent, a dispersant, and PSZ balls of 5 mm in diameter, and then a plasticizer and a binder were added to obtain slurry for sheet forming.

Next, the slurry was formed by a doctor blade method into a sheet shape on the order of 60 μm in thickness, and the obtained green sheet was then cut into a strip shape of predetermined size.

Next, a conductive paste containing Pt as a conductive component was applied onto the green sheets by a screen printing method to form conductive paste films to serve as internal electrodes.

Next, the plurality of green sheets was subjected to respective steps of stacking, pressure bonding, and cutting to obtain a green chip with a stacked structure.

Next, the green chip was subjected to a binder removal treatment at a temperature on the order of 450° C., and then firing at a temperature of 1250° C. for 48 hours in a high-purity Ar atmosphere (99.9999%). Thus, a sintered element body was obtained which had a structure with the plurality of ceramic layers and internal electrodes stacked.

Next, in order to form external electrodes on end surfaces of the element body, an Ag containing paste was applied, and then subjected to a heat treatment at a temperature of 600° C. for 48 hours under an oxygen atmosphere. Thus, resistive elements according to each sample were obtained with external electrodes formed by Ag firing on the element body.

As a result of examining the ceramic layer section of the element body by X-ray powder diffraction for the thus obtained resistive elements according to each sample, it has become obvious for all of the samples that the main constituent has a double perovskite structure.

Furthermore, the following characteristic test was carried out.

More specifically, an RTC (temperature dependency of electrical resistivity) measurement was made to obtain an inflection point of electrical resistivity and a change in resistivity. More particularly, the resistances of the resistive elements according to each sample were measured in the temperature range from −190° C. to 250° C. while applying electric fields in the range of electric field intensity from 25 V/cm to 1500 V/cm. The retention time for the resistance measurement was adjusted to 0.5 seconds.

As a typical example, FIG. 7 shows RTC characteristics for the resistive element according to sample 4. In FIG. 7, the transition temperature (T_{CTR}) is indicated by arrows for each electric field intensity of 25 V/cm, 250 V/cm, 500 V/cm, 750 V/cm, 1000 V/cm, 1250 V/cm, 1300 V/cm, and 1500 V/cm.

In addition, Table 1 shows therein, for each sample, the transition temperature (T_{CTR}) at each electric field intensity of 25 V/cm, 100 V/cm, 250 V/cm, and 1500 V/cm, and the rate of resistance change at the electric field intensity of 25 V/cm.

TABLE 1

| | | Transition Temperature (T_{CTR}) and Rate of Resistance Change | | | | |
|---|---|---|---|---|---|---|
| | | 25 V/cm | | | | |
| | | | Rate of | | | |
| Sample | | | Resistance | 100 V/cm | 250 V/cm | 1500 V/cm |
| Number | R | T_{CTR} (° C.) | Change | T_{CTR} (° C.) | T_{CTR} (° C.) | T_{CTR} (° C.) |
| 1 | Nd | 25 | 12 | 11 | −65 | Unmeasurable |
| 2 | Sm | 120 | 14 | 105 | 31 | −122 |
| 3 | Eu | 132 | 10 | 121 | 54 | −110 |
| 4 | Gd | 150 | 9 | 125 | 90 | −98 |
| 5 | Tb | 154 | 11 | 141 | 71 | −94 |
| 6 | Dy | 230 | 10 | 221 | 154 | −25 |
| 7 | Ho | 234 | 8 | 220 | 160 | −33 |
| 8 | Y | 240 | 7 | 210 | 150 | −5 |
| 9 | Nd0.5; Sm0.5 | 75 | 13 | 59 | −9 | −180 |
| 10 | Sm0.5; Gd0.5 | 125 | 13 | 119 | 50 | −129 |
| 11 | Gd0.5; Dy0.5 | 190 | 10 | 184 | 115 | −57 |
| 12 | Dy0.5; Y0.5 | 234 | 7 | 210 | 150 | −10 |

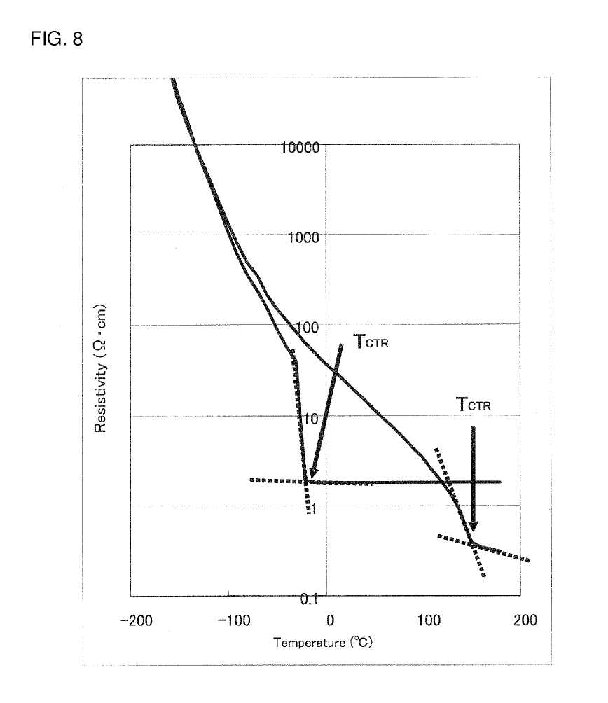

The T_{CTR} was obtained in the following way. FIG. 8 shows the case with the electric field intensity of 25 V/cm and the case with the electric field intensity of 750 V/cm, among the RTC characteristics of sample 4 shown in FIG. 7. Referring to FIG. 8, the temperature dependency of resistance before and after the transition, or before and after reaching the current limit value was approximated by lines (indicated by dotted lines) in a simple way, and the temperature corresponding to the position of the intersection of the lines was defined as T_{CTR} as a matter of convenience.

In addition, the rate of resistance change was obtained from the formula of Rate of Resistance Change=(Electrical Resistivity at Temperature 10° C. lower than T_{CTR})/(Electrical Resistivity at Temperature 10° C. higher than T_{CTR}).

As is clear from Table 1, when the applied electric field intensity is lower than 100 V/cm, the T_{CTR} shows a constant transition temperature in accordance with the ionic radius of the rare-earth element, as reported in Non-Patent Document 1, etc. However, when the electric field intensity is made higher than 100 V/cm, the T_{CTR} is decreased in accordance with the increase in electric field intensity, and the resistance change is, as is clear from FIG. 7, improved significantly as compared with the case of an electric field intensity lower than 100 V/cm.

It is to be noted that the “unmeasurable” “T_{CTR}” at “1500 V/cm” for sample 1 in Table 1 means that the T_{CTR} was not able to be measured in the case of falling below −190° C., because the temperature bath included in the measuring device used was able to be set only down to −190° C. More specifically, the “T_{CTR}” at “1500 V/cm” for sample 1 is meant to be lower than −190° C.

In addition, typical RTC characteristics are found in FIG. 7 which shows the RTC characteristics for the resistive element according to sample 4. In FIG. 7, the T_{CTR} is indicated by arrows for each electric field intensity of 25 V/cm, 250 V/cm, 500 V/cm, 750 V/cm, 1000 V/cm, 1250 V/cm, 1400 V/cm, and 1500 V/cm as mentioned above, and the T_{CTR} under each electric field intensity is also shown in Table 2 below. It is to be noted that the data in Table 2 is partially overlapped with the data in Table 1.

TABLE 2

| Electric Field | |
|---|---|
| Intensity (V/cm) | T_{CTR} (° C.) |
| 25 | 150 |
| 250 | 90 |
| 500 | 52 |
| 750 | −20 |
| 1000 | −40 |
| 1250 | −50 |
| 1300 | −72 |
| 1500 | −98 |

As is clear from FIG. 7 and Table 2, the T_{CTR} is changed in accordance with the increase in applied electric field intensity, and the T_{CTR} is decreased to lower temperatures as the electric field intensity is increased.

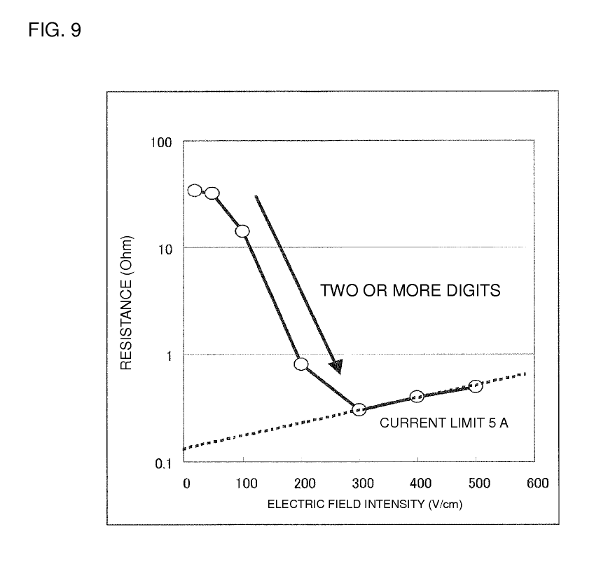

Furthermore, in order to examine the effects of the resistive element according to the present invention, the change in resistance was examined in the case of applying a pulse voltage. When the resistive element is directed to an application such as an infrared light sensor or for inrush current suppression, it is desirable for the resistive element to exhibit a larger change in resistance in a shorter period of time. FIG. 9 shows, for the resistive element according to sample 4, the result of measuring a current value with a voltage pulse (pulse width: 50 milliseconds) while gradually changing the electric field intensity at room temperature with a current limit of 5 A.

As is clear from FIG. 9, in spite of the short voltage pulse of 50 milliseconds, at room temperature, the resistance is decreased gradually at the electric field intensity of 100 V/cm or more to reach the current limit of 5 A at the electric field intensity of 300 V/cm or more. It is determined that the rate of resistance change in that case reaches two or more digits, and the use at the electric field intensity of 100 V/cm or more exhibits a larger change in resistance, and also provides an extremely fast response speed.

Further, it is determined that this change in resistance is not caused by any element breakage, because the same result is provided even when the same measurement is made repeatedly.

From the results describe above, it is determined that large changes in resistance can be achieved in various temperature ranges according to the present invention.

It is to be noted that while the additive element such as Mn added to the barium carbonate in order to obtain the composition of RBaMn₂O₆ was supposed to have the form of an oxide in the experimental example described above, it has been confirmed that other forms such as carbonates and hydroxides also produce the same results.

In addition, while the Pt containing conductive paste was used in the experimental example described above, it has been confirmed that the use of other paste such as an Ag—Pd containing conductive paste and a Pd containing conductive paste also produces the same results.

Furthermore, while the top temperature retention time in the firing step was adjusted to 48 hours in the experimental example described above, it has been confirmed that the same results are also produced even in the case of varying the retention time in the range of 24 to 48 hours.

### DESCRIPTION OF REFERENCE SYMBOLS

1 infrared light sensor

2, 21 element body

3, 4 electrode

5, 16 resistive element

7 surface layer section

8 infrared light

11 electrical device

12 alternating-current source

13 protected circuit

15 electric current line

22 ceramic layer

23, 24 internal electrode

25, 26 external electrode

1. A resistive element comprising:
an element body that contains, as its main constituent, an oxide conductor represented by a chemical formula: RBaMn₂O₆, the element body having a negative temperature coefficient; and
at least a pair of electrodes arranged to apply an electric field to at least a portion of the element body, wherein
the resistive element is configured such that when the electric field with an electric field intensity of 100 V/cm or more is applied through the pair of electrodes to the element body, a resistance of the element body changes, and
R is at least one element selected from Nd, Sm, Eu, Gd, Tb, Dy, Ho, and Y.

2. The resistive element according to claim 1, wherein the resistive element is configured to detect infrared light when the electric field with the electric field intensity of 100 V/cm or more is applied through the pair of electrodes to the element body.

3. The resistive element according to claim 1, wherein the resistive element is configured to suppress an inrush current, in such a way that the resistive element is connected in series with an electric current line to a protected circuit so that an electric field with an electric field intensity of 100 V/cm or more is applied through the pair of electrodes to the element body when an inrush current flows into the protected circuit.

4. The resistive element according to claim 3, further comprising:
an electric current line; and
a protected circuit, wherein
the resistive element is connected in series with the electric current line to the protected circuit, and
when the electric field with the electric field intensity of 100 V/cm or more is applied through the pair of electrodes to the element body, the resistive element is configured to suppress the inrush current flowing into the protected circuit.

5. An infrared light sensor comprising:
a resistive element including an element body that contains, as its main constituent, an oxide conductor represented by a chemical formula: RBaMn₂O₆, wherein R is at least one element selected from Nd, Sm, Eu, Gd, Tb, Dy, Ho, and Y, and the resistive element has a negative temperature coefficient;
at least a pair of electrodes configured to apply an electric field to a surface layer section of the element body;
a power source configured to apply the electric field through the pair of electrodes to the element body; and
a current measuring unit that measures an electric current flowing through the element body, wherein
the resistive element is configured such that when the electric field with an electric field intensity of 100 V/cm or more is applied through the pair of electrodes to the element body, a resistance of the element body changes, and
the infrared light sensor is adapted to detect a resistance change of the element body based on a temperature change due to infrared light received by the surface layer section of the element body, by measuring the resistance change as a current change with the use of the current measuring unit.

6. An electrical device comprising:
a protected circuit;
a power source;
an electric current line for supplying the electric power to the protected circuit;
a resistive element configured to suppress an inrush current into the protected circuit, the resistive element being connected in series with the electric current line, wherein the resistive element comprises: an element body that contains, as its main constituent, an oxide conductor represented by a chemical formula: RBaMn₂O₆, wherein R is at least one element selected from Nd, Sm, Eu, Gd, Tb, Dy, Ho, and Y, and the resistive element has a negative temperature coefficient; and at least a pair of electrodes configured to apply an electric field to at least a portion of the element body, and
the electrical device is configured to apply the electric field with an electric field intensity of 100 V/cm or more through the pair of electrodes to the element when an inrush current flows into the protected circuit.
